(19) United States
(12) Patent Application Publication
(10) Pub. No.: US 2017/0175948 A1
(43) Pub. Date: Jun. 22, 2017

(54) GIMBAL SYSTEM HAVING PRELOADED ISOLATION

(71) Applicant: FLIR Systems, Inc., Wilsonville, OR (US)

(72) Inventors: Stephen W. Zeise, Ocoee, FL (US); Robert Dale Anderson, Orlando, FL (US)

(21) Appl. No.: 15/128,918

(22) PCT Filed: Mar. 30, 2015
(86) PCT No.: PCT/US15/23416

§ 371 Date: Sep. 23, 2016

Related U.S. Application Data
(60) Provisional application No. 61/972,116, filed on Mar. 28, 2014.

(51) Int. Cl. F16M 11/12; G02B 27/64; G03B 17/56; G01C 21/18; B64D 47/08

(52) U.S. Cl. CPC F16M 11/126; G01C 21/18; B64D 47/08; G03B 17/561; G02B 27/644; B60R 11/04

(57) ABSTRACT

A gimbal system, including apparatus and methods, with one or more gimbals having non-preloaded or preloaded vibration isolators, a biased preloading compensation mechanism, sag compensation, and/or lateral snubbing.

### CROSS-REFERENCES

The present application claims priority to U.S. Provisional Patent Application Ser. No. 61/972,116, filed on Mar. 28, 2014.

The following related applications and materials are incorporated herein, in their entireties, for all purposes: U.S. Pat. No. 7,264,220; U.S. Pat. No. 7,515,767; U.S. Pat. No. 7,561,784; U.S. Pat. No. 7,671,311; U.S. Pat. No. 8,385,065; U.S. Provisional Patent Appl. Ser. No. 61/972,116; and PCT Publication No. WO 2012/170673.

### INTRODUCTION

Gimbal systems permit payloads, such as optical devices (e.g., cameras and lasers), to be mounted to and used on a support platform. In general, gimbal systems may include a plurality of pivotable structures (i.e., gimbals), each rotatable on a different, orthogonal axis. These systems may allow a payload supported by an innermost gimbal to be oriented substantially independent of gimbal rotation caused by the support platform. For example, vehicles, such as aircraft, watercraft, and ground vehicles, may provide moving support platforms for gimbal systems. Whether moving or stationary, a gimbal system may enable a payload to be accurately reoriented with respect to the support platform. As an example, the payload may include a camera that can be panned and tilted with respect to the support platform to survey or monitor a broad field of view.

A gimbal system may be structured as a set of separate units, termed “line replaceable units,” that are in communication with one another. For example, the gimbal system may be composed of (1) a turret unit (also termed a gimbal apparatus) that supports and orients a payload, (2) a user interface unit to permit an operator to control aspects of turret unit operation, and (3) a central electronics unit that provides additional electronic circuitry for gimbal system operation. When carried by a vehicle, the turret unit may be mounted to the exterior of the vehicle, and the user interface unit and the central electronics unit may be located inside the vehicle.

The turret unit may have a compact, aerodynamic configuration, with sensitive components, such as electronics and/or the payload, enclosed for protection from ambient (external) air, to minimize exposure to moisture, salt, particulates, etc.

### SUMMARY

The present disclosure provides systems, apparatuses, and methods relating to sag compensation, snubbing, and/or vibration isolation. In some embodiments, a gimbal system may include a support portion; a gimbal assembly pivotably connected to and supported by the support portion, the gimbal assembly including a major gimbal and a minor gimbal, the minor gimbal nested within the major gimbal and pivotable on a common axis; a vibration tray assembly including a plate having arm extensions, the plate being connected to a bearing of the pivot axis of the minor gimbal, at least one arm extension being connected to the major gimbal by a mechanical isolator; and a payload pivotably orientable with respect to the support portion by the gimbal assembly, to provide pan and tilt movement of the payload; wherein the minor gimbal is substantially isolated from vibration of the major gimbal by the vibration tray assembly.

In some embodiments, a gimbal system may include a support portion; a gimbal assembly pivotably connected to and supported by the support portion, the gimbal assembly including a major gimbal and a minor gimbal, the minor gimbal nested within the major gimbal and pivotable on a common axis; a vibration tray assembly including a plate having arm extensions, the plate being connected to a bearing of the pivot axis of the minor gimbal, at least one arm extension being connected to the major gimbal by a mechanical isolator; and a payload pivotably orientable with respect to the support portion by the gimbal assembly, to provide pan and tilt movement of the payload; wherein the minor gimbal is substantially isolated from vibration of the major gimbal by the vibration tray assembly; and wherein a space between the at least one arm extension and the major gimbal is configured to cause the mechanical isolator to be partly compressed regardless of vibration.

In some embodiments, a gimbal system may include a support portion; a gimbal assembly pivotably connected to and supported by the support portion, the gimbal assembly including a major gimbal and a minor gimbal, the minor gimbal nested within the major gimbal and pivotable on a common axis, the minor gimbal being operatively connected to the major gimbal by an assembly including a preloaded mechanical isolator; a payload pivotably orientable with respect to the support portion by the gimbal assembly, to provide pan and tilt movement of the payload; and a compensating bias mechanism operatively connected between the minor gimbal and the major gimbal.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a view of an exemplary gimbal system including a turret unit mounted to an exterior of a support platform (namely, a helicopter), in accordance with aspects of the present disclosure.

FIG. 2 is a schematic view of selected aspects of the gimbal system of FIG. 1, in accordance with aspects of the present disclosure.

FIG. 3 is a partial isometric view of an illustrative gimbal system according to aspects of the present disclosure.

FIG. 4 is an isometric view of an illustrative gimbal system having a payload housing removed and an outer yoke pivoted downward relative to an outer housing.

FIG. 5 is a sectional isometric view of an illustrative gimbal system taken vertically through a central horizontal axis.

FIG. 6 is a partial isometric view of an illustrative vibration tray assembly and inner ring according to aspects of the present disclosure.

FIG. 7 shows a view similar to FIG. 6 but with the vibration tray assembly removed.

FIG. 8 is an isometric view of an illustrative vibration tray according to aspects of the present disclosure.

FIG. 9 is an isometric view of an illustrative gimbal system with the main housing and outer yoke removed.

FIG. 10 is an isometric sectional view of the interface between an illustrative vibration tray assembly and inner ring, with the inner ring in a horizontal orientation.

FIG. 11 is a magnified isometric view of a connection between an illustrative isolator and an arm of a vibration tray according to aspects of the present disclosure.

FIG. 12 is a sectional view of an illustrative hub and bearing interface between an inner ring and outer yoke, showing spring compensation according to aspects of the present disclosure.

FIG. 13 is an isometric view of an illustrative snubber base of FIG. 12.

FIG. 14 is an isometric view of an outer surface of an illustrative outer yoke, showing a sag compensation assembly according to aspects of the present disclosure mounted to an end cap and outer yoke.

FIG. 15 is a sectional side view of the system of FIG. 14.

FIG. 16 is a partial isometric view of another illustrative sag compensation assembly in accordance with aspects of the present disclosure.

FIGS. 17 and 18 are isometric views of the sag compensation assembly of FIG. 16, showing illustrative relationships between internal and external components.

FIG. 19 is an isometric view of an illustrative sag compensation assembly similar to those of FIGS. 16-18 but having an inverted orientation for inverted gimbal systems.

FIG. 20 is a sectional view of an installed sag compensation assembly taken horizontally through a midpoint of a ball joint portion of the assembly.

### DESCRIPTION

### Overview

Various embodiments of a gimbal system having preloaded isolators, preload compensation assemblies, space saving vibration trays, damped snubber assemblies, and/or sag compensation systems, are described below and illustrated in the associated drawings. Unless otherwise specified, a gimbal system according to aspects of the present disclosure and/or its various components may, but are not required to, contain at least one of the structure, components, functionality, and/or variations described, illustrated, and/or incorporated herein. Furthermore, the structures, components, functionalities, and/or variations described, illustrated, and/or incorporated herein in connection with the present gimbal system may, but are not required to, be included in other gimbal systems. The following description of various embodiments is merely exemplary in nature and is in no way intended to limit the invention, its application or uses. Additionally, the advantages provided by the embodiments, as described below, are illustrative in nature and not all embodiments provide the same advantages or the same degree of advantages.

The gimbal system may comprise a support portion and a gimbal assembly pivotably connected to and supported by the support portion. The gimbal system further may comprise a payload, such as an optical detection device. The payload may be supported by the gimbal assembly and pivotably orientable with respect to the support portion about a pair of nonparallel axes by controlled driven motion of the gimbal assembly, to provide pan and tilt movement of the payload. The gimbal assembly may include components configured to limit vibration and/or provide mechanical isolation between the gimbal assembly and the payload, and/or between portions of the gimbal assembly, and/or between the gimbal system and the support portion.

Further aspects of the present disclosure are described in the following sections, including (I) definitions, (II) overview of an exemplary gimbal system, (III) support portions, (IV) gimbal assemblies, (V) payloads, (VI) support platforms, and (VII) examples.

### I. DEFINITIONS

Technical terms used in this disclosure have the meanings that are commonly recognized by those skilled in the art. However, the following terms may have additional meanings, as described below. The wavelength ranges identified in these meanings are exemplary, not limiting, and may overlap slightly, depending on source or context. The wavelength ranges lying between about 1 nm and about 1 mm, which include ultraviolet, visible, and infrared radiation, and which are bracketed by x-ray radiation and microwave radiation, may collectively be termed optical radiation.

Ultraviolet radiation—Invisible electromagnetic radiation having wavelengths from about 100 nm, just longer than x-ray radiation, to about 400 nm, just shorter than violet light in the visible spectrum. Ultraviolet radiation includes (A) UV C (from about 100 nm to about 280 or 290 nm), (B) UV B (from about 280 or 290 nm to about 315 or 320 nm), and (C) UV A (from about 315 or 320 nm to about 400 nm).

Visible light—Visible electromagnetic radiation having wavelengths from about 360 or 400 nanometers, just longer than ultraviolet radiation, to about 760 or 800 nanometers, just shorter than infrared radiation. Visible light may be imaged and detected by the human eye and includes violet (about 390-425 nm), indigo (about 425-445 nm), blue (about 445-500 nm), green (about 500-575 nm), yellow (about 575-585 nm), orange (about 585-620 nm), and red (about 620-740 nm) light, among others.

Infrared (IR) radiation—Invisible electromagnetic radiation having wavelengths from about 700 nanometers, just longer than red light in the visible spectrum, to about 1 millimeter, just shorter than microwave radiation. Infrared radiation includes (A) IR-A (from about 700 nm to about 1,400 nm), (B) IR-B (from about 1,400 nm to about 3,000 nm), and (C) IR-C (from about 3,000 nm to about 1 mm). IR radiation, particularly IR-C, may be caused or produced by heat and may be emitted by an object in proportion to its temperature and emissivity. Portions of the infrared range having wavelengths between about 3,000 and 5,000 nm (i.e., 3 and 5 μm) and between about 7,000 or 8,000 and 14,000 nm (i.e., 7 or 8 and 14 μm) may be especially useful in thermal imaging, because they correspond to minima in atmospheric absorption and thus are more easily detected (particularly at a distance). The particular interest in relatively shorter wavelength IR has led to the following classifications: (A) near infrared (NIR) (from about 780 nm to about 1,000 nm), (B) short-wave infrared (SWIR) (from about 1,000 nm to about 3,000 nm), (C) mid-wave infrared (MWIR) (from about 3,000 nm to about 6,000 nm), (D) long-wave infrared (LWIR) (from about 6,000 nm to about 15,000 nm), and (E) very long-wave infrared (VLWIR) (from about 15,000 nm to about 1 mm). Portions of the infrared range, particularly portions in the far or thermal IR having wavelengths between about 0.1 and 1 mm, alternatively or additionally may be termed millimeter-wave (MMV) wavelengths.

### II. OVERVIEW OF AN EXEMPLARY GIMBAL SYSTEM

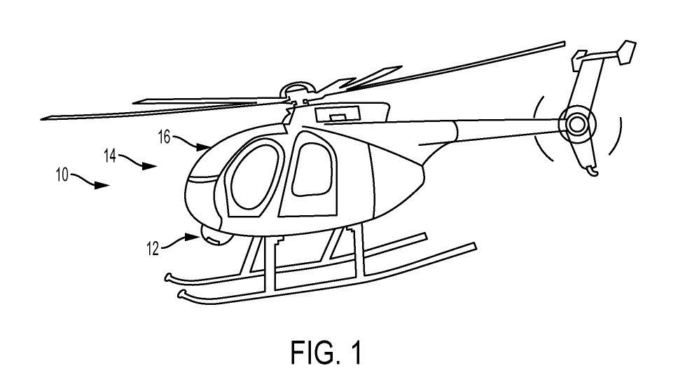

FIG. 1 shows an exemplary gimbal system 10 including a turret unit 12 (also termed a gimbal apparatus) mounted to the exterior of a support platform 14. In the present illustration, support platform 14 is a vehicle, namely, a helicopter 16. In other examples, support platform 14 may include a boat or land-based vehicle. In some examples, turret unit 12 may be oriented differently, such as by mounting at a lower end rather than an upper end as shown in FIG. 1.

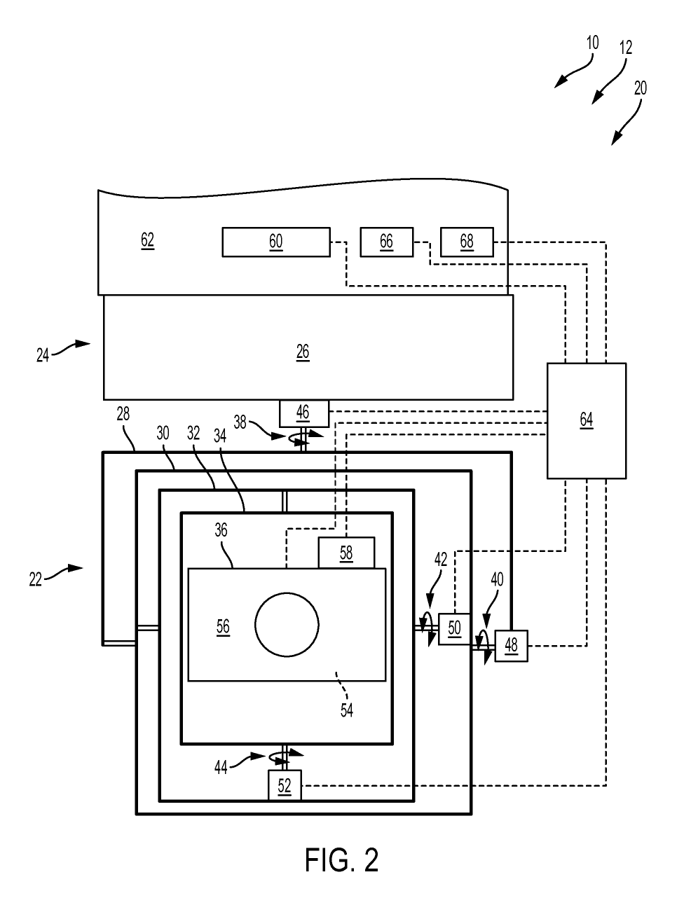

FIG. 2 shows a schematic view of selected aspects of a gimbal system 20, which is an embodiment of gimbal system 10. Gimbal assembly 22 may be connected to and supported by mount 26 (e.g., with the gimbal assembly located below or above the mount, among others) and may be pivotable collectively with respect to the mount (and the vehicle). The mount and/or a portion thereof may be relatively stationary with respect to vehicle 28, and the gimbal assembly may be relatively movable with respect to the vehicle. System 20 also may be equipped with a payload 30 (e.g., including at least one or more optical devices, such as at least one light source and/or an optical sensor (e.g., an image sensor of a camera 32)) that is orientable with respect to mount 26 (and the vehicle) by rotation of gimbals of gimbal assembly 22 about a plurality of axes (e.g., at least two nonparallel axes and/or a pair of orthogonal axes, among others).

A mount 24 may include one or more frame members 26. A frame member may be secured to a support platform via attachment features of the frame member (and/or with one or more brackets, among others). For example, the frame member may define a set of apertures to receive fasteners. The apertures may have any suitable position, such as being disposed generally centrally or near a perimeter of the frame member.

Gimbal assembly 22 may comprise a series of two or more gimbals, such as first through fourth gimbals 28, 30, 32, and 34. Each gimbal is pivotably connected to preceding and succeeding gimbals of the series, for example, via one or more axle members or axle assemblies. First gimbal 28 supports second through fourth gimbals 30, 32, 34, and payload 36, and is pivotably connected to and supported by frame member 26 for rotation about a first axis 38 (e.g., a first yaw, azimuthal, and/or vertical axis), which may extend at least generally centrally through mount 24 and/or frame member 26. Second gimbal 30 supports third and fourth gimbals 32, 34 and payload 36, and is pivotably connected to and supported by first gimbal 28 for rotation about a second axis 40 (e.g., a first pitch, elevational, and/or horizontal axis), which may be orthogonal to first axis 38. Third gimbal 32 supports fourth gimbal 34 and payload 36, and is pivotably connected to and supported by second gimbal 30 for rotation about a third axis 42 (e.g., a second pitch, elevational, and/or horizontal axis). Third axis 42 may be parallel to, and/or or coaxial with second axis 40 (or first axis 38 with the gimbal assembly in a neutral position). Fourth gimbal 34 supports payload 36, and is pivotably connected to and supported by third gimbal 32 for rotation about a fourth axis 44 (e.g., a second yaw, azimuthal, and/or vertical axis). Fourth axis 44 may be parallel to, and/or coaxial with first axis 38 (or second axis 40 with the gimbal assembly in a neutral position). The payload may or may not be fixed to the fourth gimbal. In some cases, rotation of first and second gimbals 28 and 30 may provide larger adjustments to the orientation of payload 36, and rotation of third and fourth gimbals 32 and 34 may provide smaller adjustments to the orientation (or vice versa).

Rotation of each gimbal 28-34 may be driven by a drive mechanism, such as respective motors 46, 48, 50, and 52. Each motor may be attached to its corresponding gimbal or to the structure that supports the gimbal, or a combination thereof. For example, motor 46 may be attached to frame member 26 or first gimbal 28; motor 48 to first gimbal 28 or second gimbal 30; and so on. The angular orientation of the payload may be adjusted horizontally and vertically via rotation of gimbals 28-34, without changing the orientation of the support platform, and/or the payload may continue to point at a target as the attitude and location of the support platform changes, among others. Accordingly, the gimbal system may allow one or more fixed and/or moving targets to be monitored or tracked over time from a fixed and/or moving support platform.

The gimbal system also may comprise one or more sensors to sense aspects of the vehicle, of one or more gimbals, of the payload, or of a target. Exemplary sensors include an orientation sensor (e.g., a gyroscope that measures angular position or rate of angular change, among others), an accelerometer, an optical sensor to detect optical radiation (e.g., an image sensor 54 in a camera 56), or the like, or any combination of these. At least one gimbal of the gimbal assembly and/or the payload may be attached to at least one gyroscope 58 to measure the orientation of the gimbal and/or payload. In some cases, the gimbal system may include at least one inertial measurement unit (IMU) 60, which may be carried by gimbal assembly 22 (e.g., by payload 36 or fourth gimbal 34), and/or a supporting vehicle 62. The IMU may include sensors to measure acceleration along three orthogonal axes and angular position/change about three orthogonal axes. Measurements from unit 60 alone or in combination with those from one or more other gyroscopes of the gimbal assembly may be used to aim the payload with respect to an inertial reference frame (e.g., the earth), as the vehicle travels with respect to the reference frame.

Gimbal system 20 also may comprise a processor 64, and a user control unit 66 to communicate inputs, such as user preferences, commands, etc., to the processor. The processor may be included in gimbal assembly 22 (and/or mount 24), vehicle 62, or a combination thereof, among others. The user control unit may be disposed in the vehicle, if the vehicle has a person onboard, or may be disposed elsewhere (e.g., on the ground) if the vehicle is unmanned.

The processor may include any electronic device or set of electronic devices responsible for signal processing, manipulation of data, and/or communication between or among gimbal system components. The processor may be localized to one site or may be distributed to two or more spaced sites of the gimbal system. The processor may be programmed to receive user inputs from user control unit 66 and to control operation of and/or receive signals from any suitable system components, as indicated by dashed lines in FIG. 2, for example, the motors, sensors (e.g., one or more optical devices, one or more IMU's, gyroscopes, accelerometers, etc.), payload 36, a display 68 carried by vehicle 62, and so on. Accordingly, the processor may be in communication with the motors, sensors, and display, to receive signals from and/or send signals to these devices, and may be capable of controlling and/or responding to operation of these devices. Also, the processor may be responsible for manipulating (processing) image data (e.g., a representative video signal) received from camera 56 before the signal is communicated to display 68, to drive formation of visible images by the display.

Gimbal assembly 22 may include and/or be connected to a power supply. The power supply may include any mechanism for supplying power, such as electrical power, to the motors, sensors, payload, processor, etc. The power supply may be provided by the support platform, the mount, the gimbal apparatus, or a combination thereof, among others. Suitable power supplies may generate, condition, and/or deliver power, including AC and/or DC power, in continuous and/or pulsed modes. Exemplary power supplies may include batteries, AC-to-DC converters, DC-to-AC converters, and so on.

Additional features and aspects that may be suitable for the gimbal system are disclosed, for example, in U.S. Pat. No. 7,671,311.

### III. SUPPORT PORTIONS

A support portion may be any part of a gimbal system that supports a gimbal assembly. In some cases, the support portion may include a mounting/control portion that connects a gimbal assembly to a support platform and/or that carries electronics providing one or more aspects of gimbal system control and/or data processing. The support portion may form an end region of a turret unit. Also, this portion may be unstabilized and may be termed a “skillet.”

The support portion may support a gimbal assembly and may be connected directly to at least one gimbal and connected indirectly to one or more additional gimbals of the gimbal assembly. The support portion, in turn, may be attached to a support platform (see Section VI) or may rest upon a support platform without attachment thereto. The support portion may be mounted to a support platform via any suitable mechanism, with any suitable orientation. For example, when used with a vehicle, a support portion (and/or the corresponding turret unit) may be bottom-mounted, side-mounted, top-mounted, front-mounted, rear-mounted, externally mounted, internally mounted, and/or so on. Moreover, such mounting may be static or dynamic, for example, involving additional gimbal(s) to provide dynamic mounting. The support portion may carry and/or contain any suitable components of a turret unit, including a controller(s), power supply, electrical conduits or other electrical circuitry, a fan(s), and/or the like.

The support portion may have any suitable shape. In some embodiments, the support portion may be at least generally cylindrical. The support portion may be shaped at least generally as a disc.

### IV. GIMBAL ASSEMBLIES

A gimbal assembly, as used herein, is a hierarchical arrangement of two or more pivotable members (gimbals). A gimbal assembly may include a higher-order gimbal pivotally coupled directly to a support portion. The gimbal assembly also may include a lower-order gimbal pivotally coupled directly to the higher-order gimbal and indirectly to the support portion, such that the lower-order gimbal is carried by the higher-order gimbal. As a result, pivotal motion of the higher-order gimbal in relation to the support portion results in collective pivotal motion of both gimbals, whereas pivotal motion of the lower-order gimbal may be independent of the higher-order gimbal. The gimbal assembly further may include any suitable number of additional lower-order gimbals that are pivotally coupled directly to a relatively higher-order gimbal and/or that carry an even lower-order gimbal.

A gimbal assembly may be configured to rotate a payload about any suitable or desired number of axes, including 2, 3, 4, 5, 6, or more axes. In some embodiments, some of the axes of rotation may be collinear or coplanar. The axes of rotation typically are either orthogonal to one another or parallel to (including collinear with) one another, although this is not required. In some embodiments, parallel axes of rotation, or substantially parallel axes, can be used to provide increased precision, with a first level of rotation about a first axis providing coarser large-magnitude adjustments and a second level of rotation about a second axis (parallel or nonparallel) to the first axis providing finer small-magnitude adjustments.

Each gimbal of a gimbal assembly may be capable of any suitable pivotal motion. The pivotal motion may be a complete revolution (360 degrees) or less than a complete revolution. In some embodiments, the gimbal assembly may include a hierarchical arrangement of major and minor gimbal pairs. The major gimbal pair may be a pair of gimbals having a relatively larger range of angular motion (such as greater than about 90 degrees). The minor gimbal pair may be a pair of gimbals that are pivotally coupled to the major gimbal pair (and indirectly to the support portion) and having a relatively smaller range of angular motion (such as less than about 90 degrees).

Each gimbal of a gimbal assembly may be driven controllably by a driver. An exemplary driver that may be suitable is described in U.S. Pat. No. 7,561,784.

### V. PAYLOADS

A payload includes any device that is carried and aimed by a gimbal assembly. The payload may include one or more detectors and/or emitters, among others. A detector generally comprises any mechanism for detecting a suitable or desired signal, such as electromagnetic radiation, an electric field, a magnetic field, a pressure or pressure difference (e.g., sonic energy), a temperature or temperature difference (e.g., thermal energy), a particle or particles (e.g., high energy particles), movement (e.g., an inertial measurement device), and/or the like. An emitter generally comprises any mechanism for emitting a suitable or desired signal, such as electromagnetic radiation (e.g., via a laser), sonic energy, and/or the like. The payload generally is in communication with a controller that sends signals to and/or receives signals from the payload. The payload may be coupled (generally via a controller) to a display such that signals from the payload may be formatted into a visual form for viewing on the display. The present disclosure may be especially useful when the payload contains high heat-emitting components, such as lasers, radars, millimeter-wave (MMW) imagers, light detection and ranging (LIDAR) imagers, mine-detection sensors, and/or inertial measurement units (IMUs).

In some embodiments, the payload may form a detection portion (or all) of an imaging system. An imaging system generally comprises any device or assembly of devices configured to generate an image, or an image signal, based on received energy, such as electromagnetic radiation. Generally, an imaging system detects spatially distributed imaging energy (e.g., visible light and/or infrared radiation, among others) and converts it to a representative signal. Imaging may involve optically forming a duplicate, counterpart, and/or other representative reproduction of an object or scene, especially using a mirror and/or lens. Detecting may involve recording such a duplicate, counterpart, and/or other representative reproduction, in analog or digital formats, especially using film and/or digital recording mechanisms. Accordingly, an imaging system may include an analog camera that receives radiation (e.g., optical radiation) and exposes film based on the received radiation, thus producing an image on the film. Alternatively, or in addition, an imaging system may include a digital camera that receives radiation (e.g., optical radiation) and generates a digital image signal that includes information that can be used to generate an image that visually portrays the received radiation. Alternatively, or in addition, an imaging system may include an active component such as a laser to illuminate a scene and form an image from one or more reflections of the laser. “Imaging energy,” as used herein, may include any type of energy, particularly electromagnetic energy, from which an image can be generated, including but not limited to ultraviolet radiation, visible light, and infrared radiation.

Suitable detectors for an imaging system may include (1) array detectors, such as charge-coupled devices (CODs), charge-injection devices (CIDs), complementary metal-oxide semiconductor (CMOS) arrays, photodiode arrays, microbolometers, and the like, and/or (2) arrays of point detectors, such as photomultiplier tubes (PMTs), photodiodes, pin photodiodes, avalanche photodiodes, photocells, phototubes, and the like. Detectors may be sensitive to the intensity, wavelength, polarization, and/or coherence of the detected imaging energy, among other properties, as well as spatial and/or temporal variations thereof.

The imaging system also may include optics (i.e., one or more optical elements). Exemplary optical elements may include (1) reflective elements (such as mirrors), (2) refractive elements (such as lenses), (3) transmissive or conductive elements (such as fiber optics or light guides), (4) diffractive elements (such as gratings), (5) subtractive elements (such as filters), and/or (6) electro-optic elements (such as a Kerr cell or a Pockels cell), among others.

The imaging system also may contain gyroscopes and/or other elements arranged to form an inertial measurement unit (IMU) on an optical bench. The IMU may be used to assess the pointing angle of the line-of-sight, as well as geo-location, geo-referencing, geo-pointing, and/or geo-tracking in earth coordinates.

In some embodiments, the imaging system may be capable of generating image signals based on reflection from a self-contained laser and/or other light or radiation source. The generated image may or may not contain range information. Such imagers may generate large amounts of heat. The present disclosure may enable the use and incorporation of light detection and ranging (LIDAR) systems, such as 3-D LIDAR systems, into gimbal systems in which the large amounts of associated heat would otherwise prevent their use.

In some embodiments, an imaging system may be capable of generating image signals based on two or more different types or wavebands of imaging energy. For example, the imaging system may be configured to generate a first image signal representative of visible light and a second image signal representative of infrared radiation. Visible light and infrared radiation are both types of electromagnetic radiation (see Definitions); however, they are characterized by different wavebands of electromagnetic radiation that may contain or reflect different information that may be used for different purposes. For example, visible light may be used to generate an image signal that in turn may be used to create a photograph or movie showing how a scene appears to a human observer. In contrast, infrared radiation may be used to generate an image signal that in turn may be used to create a heat profile showing heat intensity information for a scene. More generally, the imaging system may be used with any suitable set of first and second (or first, second, and third (and so on)) image signals, using any suitable wavelength bands. These suitable image signals may include first and second visible wavebands, first and second infrared wavebands, mixtures of visible, infrared, and/or ultraviolet wavebands, and so on, depending on the application.

In some examples, an imaging system may form composite images. The composite images may be straight combinations of two or more other images. However, in some cases, one or both of the images may be processed prior to or during the process of combining the images. Composite images may be formed for use in firefighting, aeronautics, surveillance, and/or the like, for example, by superimposing infrared images of hot spots, runway lights, persons, and/or the like on visible images.

The payload alternatively, or in addition, may include non-imaging systems, such as laser rangefinders, laser designators, laser communication devices, polarimeters, hyperspectral sensors, and/or the like.

Further aspects of imaging systems that may be suitable for the gimbal system of the present disclosure are described in the following patent, which is incorporated herein by reference: U.S. Pat. No. 7,515,767.

### VI. SUPPORT PLATFORMS

The gimbal system of the present disclosure may include a turret unit supported by a support platform. A support platform, as used herein, generally refers to any mechanism for holding, bearing, and/or presenting a turret unit and its payload. The support platform may be moving, movable but stationary, or fixed in relation to the earth, and may be disposed on the ground, in the air or space, or on and/or in water, among others. In any case, the support platform may be selected to complement the function of the turret unit and particularly its payload.

The support platform may be movable, such as a vehicle. Exemplary vehicles include a ground vehicle (e.g., a car, truck, motorcycle, tank, etc.), a watercraft (e.g., a boat, submarine, carrier, etc.), an aircraft or airborne device (e.g., a fixed-wing piloted aircraft, pilotless remote-controlled aircraft, helicopter, drone, missile, dirigible, aerostat balloon, rocket, etc.), or the like.

The support platform may be fixed in position. Exemplary fixed support platforms may include a building, an observation tower, and/or an observation platform, among others. In some embodiments, the support platform may be a temporarily stationary movable support, such as a hovering helicopter and/or a parked car, truck, or motorcycle, among others.

A gimbal system with a moving, temporarily stationary, or fixed support platform may be used for any suitable application(s). Exemplary applications for a gimbal system include navigation, targeting, search and rescue, law enforcement, firefighting, and/or surveillance, among others.

### VII. EXAMPLES, COMPONENTS, AND ALTERNATIVES

The following examples describe selected aspects of exemplary gimbal systems with preloaded vibration isolation mechanisms, preload compensation assemblies, space saving vibration trays, damped snubber assemblies, and/or sag compensation systems, as well as related systems and/or methods. These examples are intended for illustration and should not be interpreted as limiting the entire scope of the present disclosure. Each example may include one or more distinct inventions, and/or contextual or related information, function, and/or structure.

### Example 1

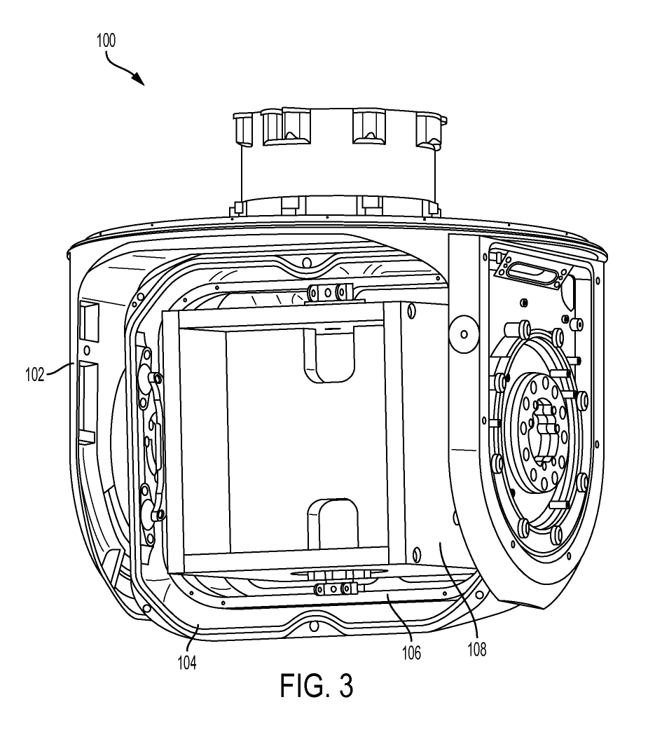

As shown in FIGS. 3-11, this Example describes an illustrative gimbal system 100 having a vibration tray assembly providing vibration isolation between a major gimbal and a corresponding minor gimbal. The exemplary vibration tray assembly may facilitate compact packaging, internal space savings, and prolonged isolator lifespan.

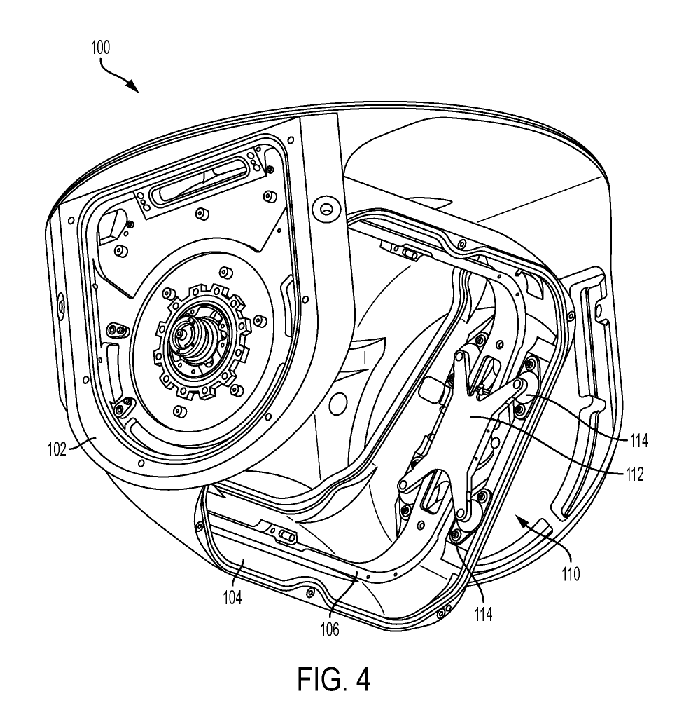

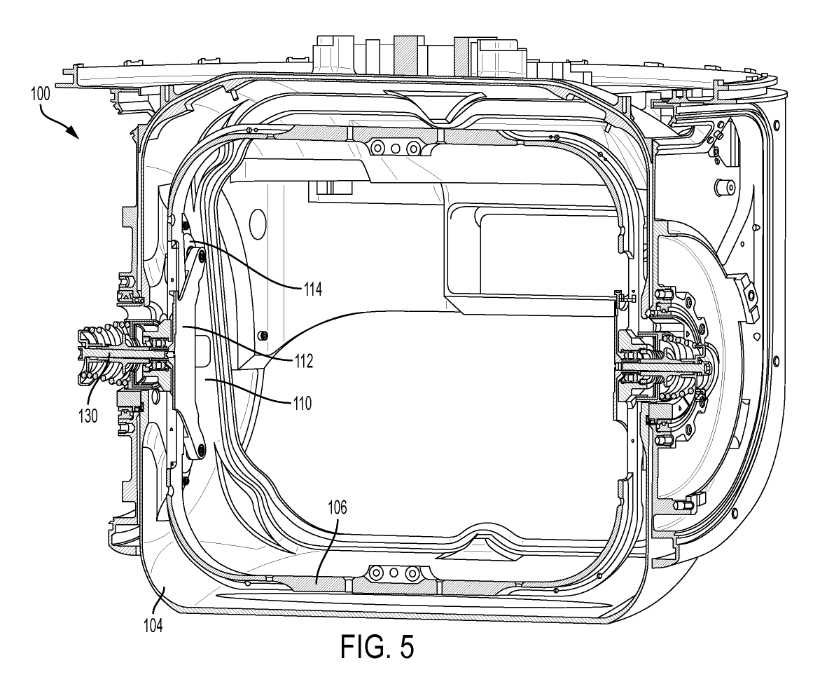

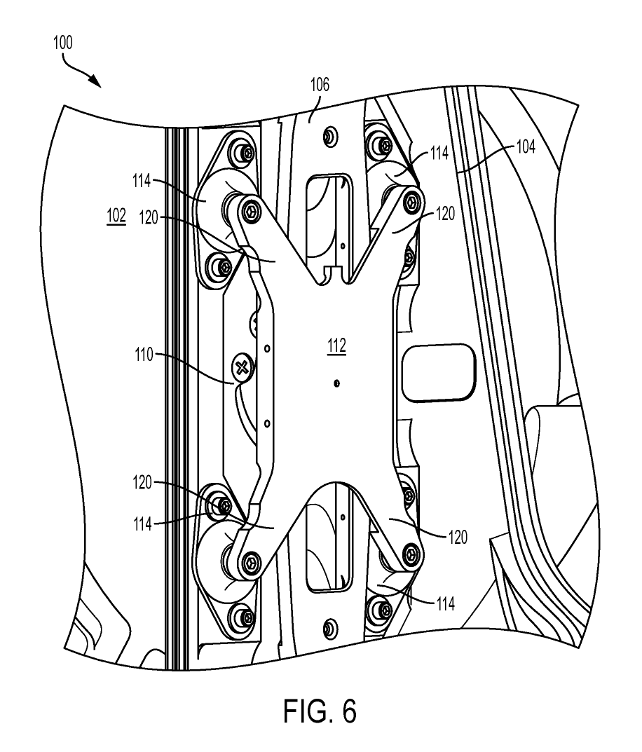

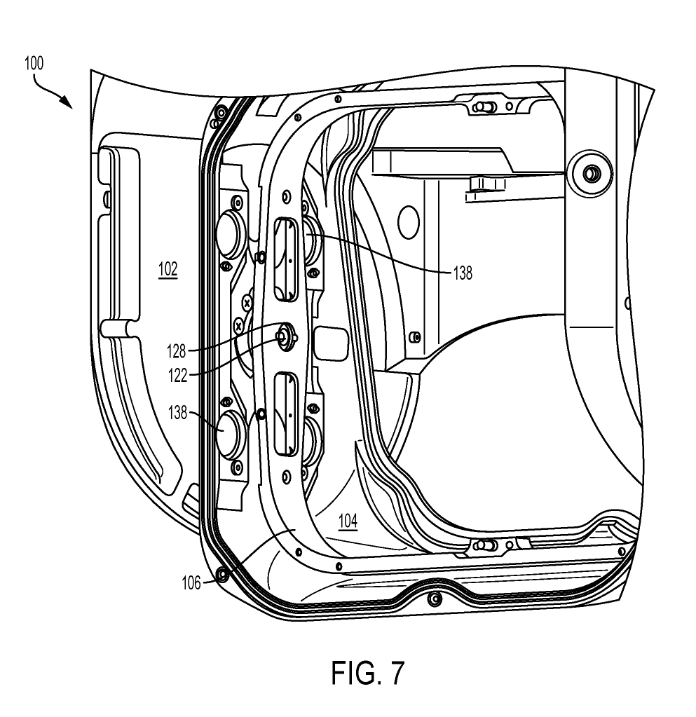

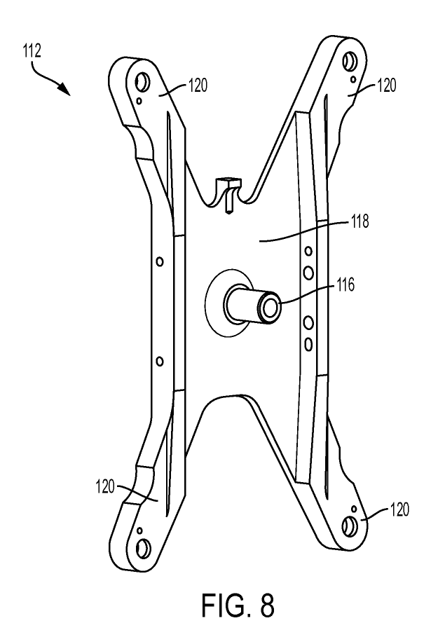

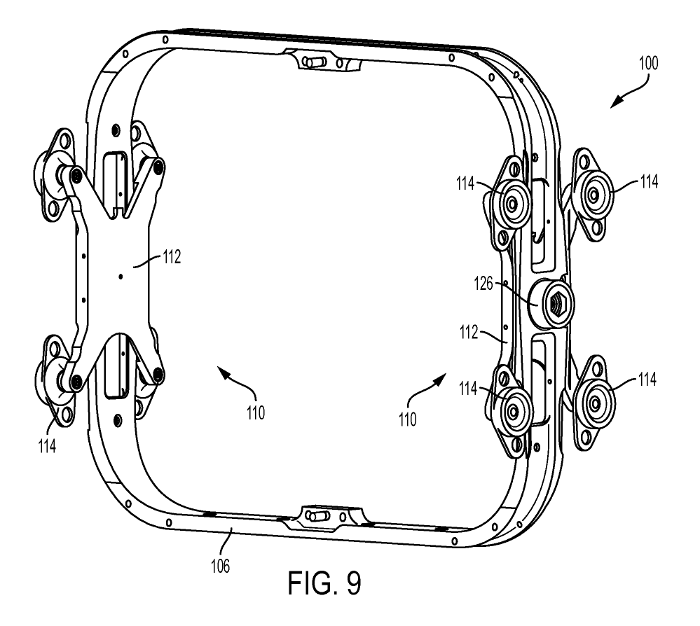

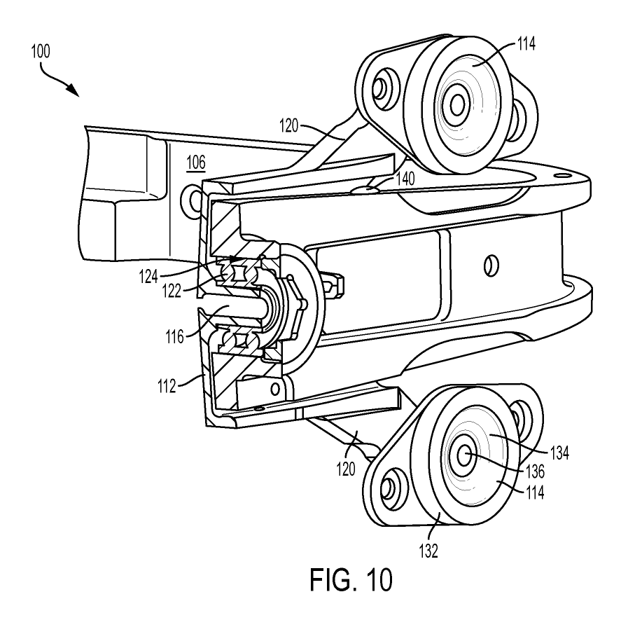

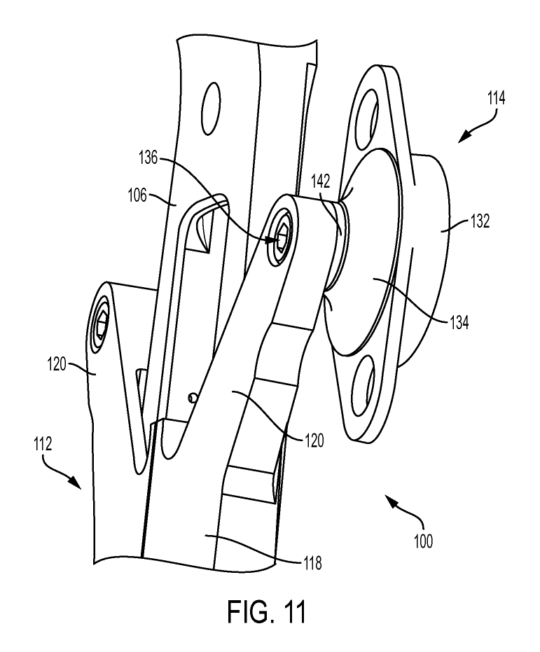

In this example, FIG. 3 is a partial isometric view of gimbal system 100; FIG. 4 is another isometric view of gimbal system 100 with a payload housing removed and an outer yoke pivoted downward relative to an outer housing; FIG. 5 is a sectional isometric view of gimbal system 100 taken vertically through a central horizontal axis; FIG. 6 is a partial isometric view of an installed vibration tray assembly and inner ring; FIG. 7 shows a view similar to FIG. 6 but with the vibration tray assembly removed; FIG. 8 is an isometric view of a vibration tray; FIG. 9 is an isometric view of gimbal system 100 with the main housing and outer yoke removed; FIG. 10 is an isometric sectional view of the interface between the vibration tray assembly and the inner ring, with the inner ring in a horizontal orientation (unlike its orientation in other figures); and FIG. 11 is a magnified isometric view of a connection between an isolator and an arm of the vibration tray.

Gimbal system 100 is shown in partial isometric view in FIG. 3, and is substantially similar to the gimbal assembly portions of gimbal system 10 shown schematically in FIG. 2. Gimbal system 100 may include a main housing (interchangeably referred to as a gimbal housing) 102, pivotally connected to an outer yoke 104, which in turn is pivotally connected to an inner ring 106. A payload housing 108 may be mounted to the inner ring as shown in FIG. 3. Generally speaking, gimbal housing 102 may be configured to rotate side to side about a vertical axis, and outer yoke 104 may be configured to rotate up and down about a horizontal axis (see FIG. 4). Inner ring 106 may be configured to rotate on an axis parallel or identical to the axis of outer yoke 104, but with a more limited range of motion and/or finer control.

It is desirable to isolate the payload as much as possible from frictional and vibrational effects caused by its connection to the outer structures of gimbal system 100. For example, vibration may be transferred between the support platform and components of the gimbal system, and aspects of the vibration may be transferred between outer yoke 104 and inner ring 106. Accordingly, a vibration tray assembly 110 may be provided to isolate inner ring 106 from vibration of outer yoke 104 at each lateral interface between the ring and the yoke.

Each vibration tray assembly 110 may be operatively connected between outer yoke 104 and inner ring 106, and may include a vibration tray 112, one or more vibration isolators 114 connecting tray 112 to outer yoke 104, and a bearing interface member 116 operatively connecting tray 112 to inner ring 106. To provide proper vibration isolation, the vibration trays may function as the only structural connection between the outer yoke and the inner ring. As will be described further below, vibration tray assemblies 110 facilitate significant space savings over alternative structures, because the trays wrap through and/or around the inner ring, allowing associated isolator components to take up space parallel to the inner ring rather than directly between the inner ring and the outer yoke.

Vibration tray 112 may include any suitable structure configured to provide a rigid interface between a central hub of inner ring 106 and a surface of outer yoke 104, through isolators 114. For example, vibration tray 112 may include a substantially planar central plate 118 having a plurality (such as four) arms 120 extending from a periphery of the central plate. The arms may be thicker than the central plate, such that the central plate forms a recess in which the inner ring may nest relative to the arms. This arrangement may be seen in FIGS. 8-10, and may be described as the “wrap-around” feature of the tray and assembly. Each arm 120 may include a mounting structure for attaching, fastening, or otherwise securing an isolator 114 that may be further secured to outer yoke 104. Tray 112 may be centered fore and aft on inner ring 106. Arms 120 may extend outward to span the inner ring, leaving space for the inner ring to pivot within a planned range of motion, such as a few degrees.

Each vibration tray 112 may include a bearing interface member 116 protruding from central plate 118. Bearing interface member 116 may be unitary or separable from tray 112, and may include any suitable protrusion configured to operationally connect tray 112 to a rotating hub of inner ring 106. For example, member 116 may include an axle or spindle configured to fit within a central bearing 122. Member 116 may be configured to fit into central bearing 122 through a window or aperture 128 in the inner ring. Central bearing 122 may be fit into a bearing housing 124 of a hub 126. Hub 126 may be a lateral protrusion of inner ring 106, and may function as a pivot point for the inner ring relative to the outer yoke. Bearing 122 may include any suitable bearing, such as a paired or duplex bearing having inner and outer races. Member 116 may be secured axially by a retention member 130, such as a screw, bolt, or other suitable fastener.

Isolators 114 (interchangeably referred to as mechanical isolators and/or vibration isolators) may include any suitable device configured to mechanically isolate vibration of one component from another, and may be passive or active. For example, each isolator 114 may include a rigid base portion 132 separated from a rigid mounting portion 134 by a resilient (e.g., rubber) pad, truncated cone, or other spring-like portion 136. In operation, vibration of one rigid portion is damped by the rubber interface before being transferred to the other rigid portion. Isolators and their modes of failure are discussed further below. In this example, base 132 of each isolator is fixed to a corresponding recess or pocket 138 in outer yoke 104. Similarly, mounting portion 134 of each isolator may be connected to a corresponding arm 120 of tray 112.

Accordingly, outer yoke 104 may be operatively connected to inner ring 106, such that inner ring 106 is pivotable in a limited manner relative to the outer yoke. In other words, outer yoke 104 may be connected to isolators 114, isolators 114 may be connected to tray 112, tray 112 may be rotatably connected to bearing 122, bearing 122 may be rotatably connected to hub 126, and hub 126 may be connected or a unitary part of inner ring 106. Arms 120 of tray 112 may be configured to allow sufficient space to avoid interference with pivoting of inner ring 106. As best seen in the sectional view of FIG. 10, inner ring 106 may include a button or bumper 140 comprising resilient material that functions as a cushion between a pivoting inner ring and the inner walls of an adjacent arm of vibration tray 112.

Isolators 114 are typically designed to function adequately until an end of life condition in which the rubber portion fails through fatigue and/or tearing. However, the inventors have determined that another mode of failure may occur much earlier than the expected fatigue-induced end of life, namely adhesive failure between the rubber portion and one or both of the rigid portions. For example, mounting portion 136 may be attached to rubber portion 134 by an adhesive. Repeated compression and tension at this adhesive interface may cause early failure. However, this unexpected problem may be overcome by preloading the isolator such that the isolator is constantly in a state of compression. When the isolator is preloaded by an amount that leaves a sufficient remaining range of motion, further vibration or oscillation only causes various degrees of compression of the rubber itself. The adhesive interface is therefore not disturbed.

Turning now to FIG. 11, one possible mechanism for preloading the isolators is shown. Namely, a shim 142 may be installed between arm 120 and isolator 114. Shim 142 may include any suitable spacer configured to rigidly space isolator 114 relative to arm 120. Because the space provided between arm 120 and recess 138 is fixed and limited, adding shim 142 will compress isolator 114 by an amount corresponding to the size of the shim. For example, a shim having a thickness of 0.040 inches may be used. In other examples, different sized shims may be used. In other examples, shims may be added in other locations, such as under base portion 132. In other examples, shim functionality may be satisfied by resizing one or more rigid portions of the isolator such that the isolator places itself into compression when installed.

### Example 2

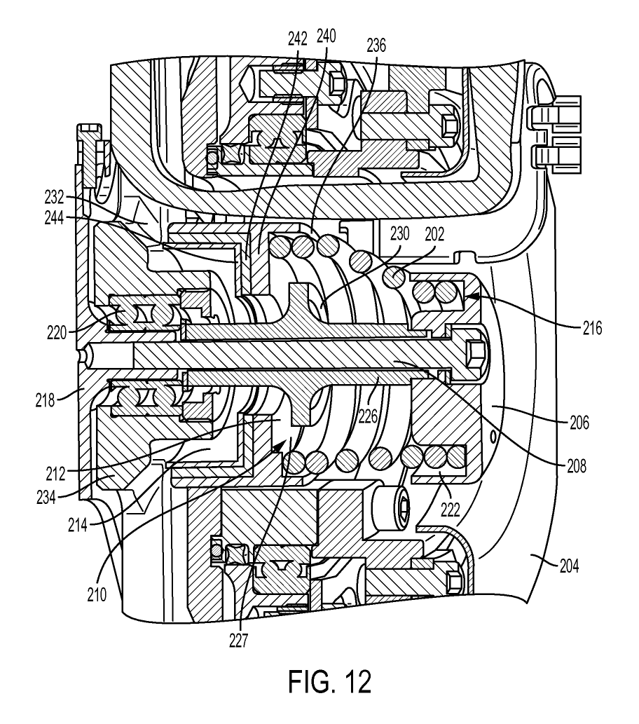

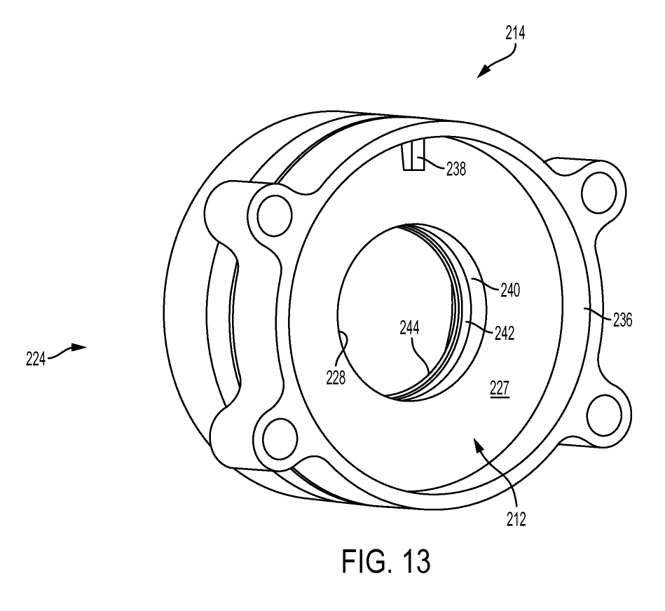

This example describes an illustrative gimbal system 200 having axially preloaded vibration isolators and preload compensation springs associated with the operative connection between a minor gimbal and a major gimbal. The exemplary system may provide prolonged isolator lifespan, reduced bearing load, and reduction or elimination of payload sag; see FIGS. 12-13.

In this example, FIG. 12 is a sectional view of a hub and bearing interface between the inner ring and the outer yoke, showing spring compensation; FIG. 13 is an an isometric view of a snubber assembly suitable for use in system 200.

As described above in Example 1, isolators 114 may be preloaded in any suitable fashion to prolong expected lifespan. However, in addition to extending the lifespan of the isolators, this preloading also exerts a lateral force on the central bearing (bearing 122 above) that would otherwise not be felt. As mentioned above, it is desirable to avoid both vibration and friction at this fine axis interface. Accordingly, a compensating force may be exerted in an opposite lateral direction.

As shown in FIG. 12, one method for compensating for the preload force on the isolators is to provide a compression spring operatively connected between the outer yoke and the vibration tray such that it pulls the vibration tray toward the outer yoke and counteracts the force imposed by preloading the isolators. Such a spring is one example of a compensating bias mechanism, in this case being biased to compensate for a lateral force caused by preloading of the mechanical isolators.

FIG. 12 is a sectional view showing one embodiment of a compensating spring 202 mounted between an outer yoke 204 and an end cap 206 that is attached to a retention member 208. Retention member 208 is similar to retention member 130, in that the member is attached at the other end to the protrusion at the center of a vibration tray.

Compensating spring 202 may include any suitable biasing mechanism, such as a helical compression spring. As shown in FIG. 12, compensating spring 202 may include a tapered or conical spring. Utilizing a tapered spring facilitates additional functionality, in that a tapered spring will provide substantially more sideways force when deflected radially than a similarly sized straight spring will. The inventors have taken advantage of this added functionality to solve a related problem, as described below.

As shown in FIG. 12, spring 202 may be generally coaxial with a central bearing, at least at the base or proximal end 210 of the spring. Spring 202 may be disposed between (a) a retaining structure 212 formed in a snubber base 214 (described below) at proximal end 210, and (b) an end cap 206 at a distal end 216. Snubber base 214 may be affixed, attached, and/or hard mounted to the outer yoke. End cap 206 may be fixedly attached to a vibration tray 218 through retention member 208. Accordingly, spacing between the retaining structure and the end cap may be fixed and/or selected such that the spring is placed in a predetermined state of compression.

Furthermore, spring 202 may be radially displaced by a fixed amount at distal end 216, as shown in FIG. 12. Radial displacement of the distal end of spring 202 results in an opposite force at the tray and inner ring. This functionality may be used to counteract a known problem. Namely, the force of gravity on the payload causes the payload to droop or “sag” on the non-rigid isolators, reducing space in the chamber and adding stress to central bearings 220. Accordingly, distal end 216 of spring 202 may be displaced in a downward direction (relative to gravitational forces), resulting in an upward force on the payload, thereby counteracting the sag. In this sense, spring 202 again functions as a compensating bias mechanism, in this case being biased to compensate for the force of gravity.

In the embodiment shown in FIG. 12, distal end 216 is displaced at a 45-degree downward angle by end cap 206. End cap 206 is an eccentric structure connectable to retention member 208 at an off-center aperture. A circumferential retaining slot 222 may be formed in the inboard surface of cap 206, and may be configured to receive and radially retain distal end 216 of spring 202. In other examples, slot 222 may be off-center even if cap 206 is not itself eccentric.

Because proximal end 210 of spring 202 is coaxial with retention member 208, and retaining slot 222 is not coaxial with the retaining member, distal end 216 will be displaced radially. The radial displacement may be oriented at any suitable angle. For example, radial displacement may be at a 45-degree downward angle to counteract expected gravitational forces. This angle may correspond to a typical orientation of the outer yoke during operation of the gimbal system on an airborne support platform. In this case the orientation of the outer yoke may be referred to as the “look-down angle.” More specifically, when the look-down angle of the outer yoke is 45 degrees (as in FIG. 4), the 45-degree offset of spring 202 will cause the offset-induced force to be oriented vertically and thus aligned counter to the gravitational force. In other examples and on other support platforms, angles other than 45 degrees may be suitable. On water- or ground-based support platforms, for example, effects of gravity would typically be 180 degrees from those discussed above and shown in the drawings. Angles such as 45 degrees may be suitable for a range of applications, because they will provide a strong vector of sag compensation at various typical look-down angles.

Distal end 216 may be radially displaced any suitable amount to counteract and/or compensate for expected sag, and may be compressed axially any suitable amount to compensate for expected preload forces. For example, a conical spring may have 0.84 axial compression, and/or 0.18 radial offset to provide 11 lbs of side-force sag compensation and 36.4 lbs of axial force at compressed height of 1.068″, with additional 0.23″ travel for sway space.

FIG. 13 is an isometric view of snubber assembly 224, which is a damped snubber assembly disposed between a major gimbal and a minor gimbal to provide mechanical snubbing on one or more axes.

Referring back to FIGS. 3-5, it is noted that the inner ring and attached payload may be jarred or otherwise jostled side to side relative to the main housing. It is therefore desirable to limit the amount of jarring that is experienced along this axis. Accordingly, a snubber assembly 302 may be utilized to provide mechanical snubbing as well as other functions.

Snubber assembly 224 may include snubber base 214 and a flanged snubber shaft 226. In general, snubber base 214 is a rigid cylindrical component having a major face 227 with a central aperture 228 through which shaft 226 passes. Aperture 228 may be larger than the main diameter of shaft 226. Shaft 226 accordingly has a freedom of axial motion, and possibly some freedom of radial motion, relative to snubber base 214. However, shaft 226 also includes flange 230, which may be disposed outboard of face 227. Flange 230 is larger than aperture 228, and configured such that axial motion of shaft 226 is halted when the flange encounters the face of the snubber.

Snubber base 214 may be affixed to, attached to, and/or form part of an outboard surface of an outer yoke 232, such as surrounding the hub of an inner ring 234. Shaft 226 may be attached to or form part of retention member 208, thereby rigidly attaching to a vibration tray 238. This arrangement allows lateral motion between the tray/inner ring and the outer yoke to be limited in either lateral direction. Similar to the snubbing action described above when flange 230 encounters face 226, the hub of inner ring 234 may also encounter face 226 if lateral motion is in the other direction, thereby providing additional snubbing. The mechanical limitation may therefore be described as both forward and reverse snubbing.

Snubber base 214 may include spring retention structure 212 described above. Spring retention structure 212 may include a circumferential wall 236 surrounding face 227, and a clocking tab 238 on the face to function as a spring positioner and support. Clocking tab 238 may function as a mechanical stop for the terminal end of spring 202, to prevent free rotation of the proximal end portion of the spring.

Snubber base 214 may include a plurality of sandwiched layers, such as a first rigid layer 240, a resilient layer 242, and a second rigid layer 244. Rigid layers 240 and/or 244 may comprise any suitable rigid material such as a metal (e.g., aluminum or steel). Resilient layer 242 may comprise rubber, foam, and/or any suitable resilient material. This sandwiched arrangement may provide a level of resilience and damping to the snubber assembly. The rigid surfaces may provide tough, hard interfaces with other components that are configured to strike or contact the base, and the resilient surface may provide a level of “give” to the structure to cushion any shocks during snubbing.

### Example 3

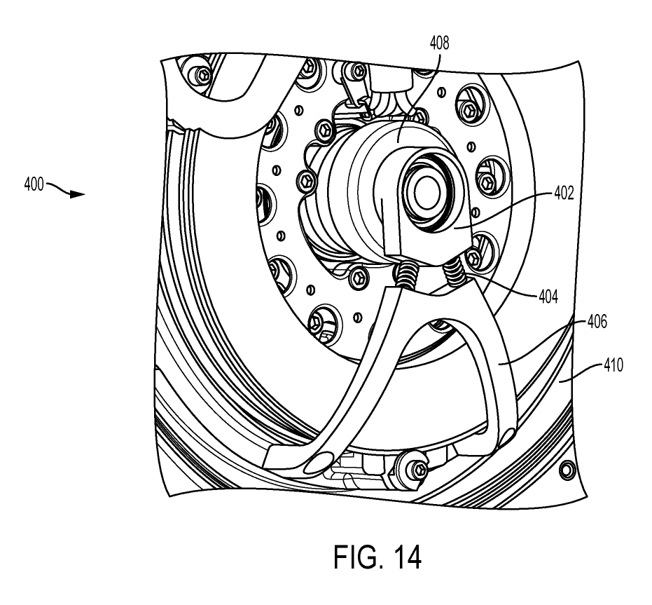

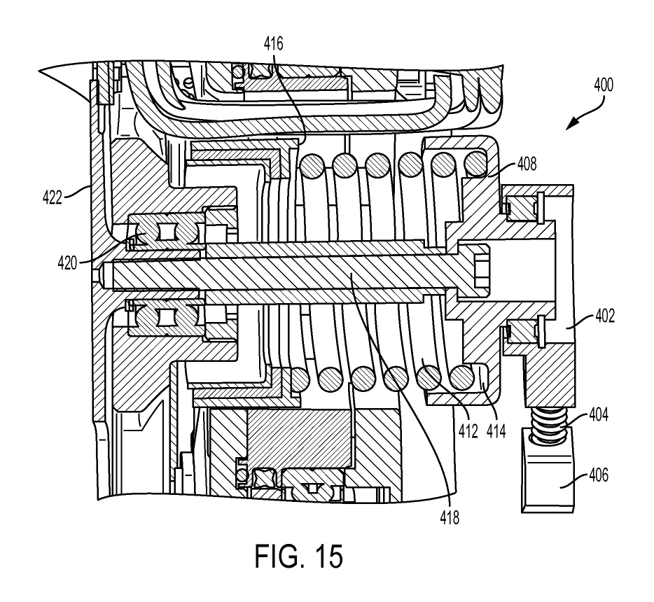

This example describes an illustrative gimbal system having an externally mounted sag compensation assembly 400 between a major gimbal and a minor gimbal. The exemplary system may provide improved compensation for payload sag as described above at a greater range of look-down angles; see FIGS. 14-15.

In this example, FIG. 14 is an isometric view of an outer surface of an outer yoke, showing sag compensation assembly 400 mounted to the end cap and outer yoke; and FIG. 15 is a sectional side view of the same portion of the gimbal system.

Sag compensation assembly 400 (also referred to as a compensating bias mechanism) may include a bearing mount 402, a set of springs 404, and a brace 406. Bearing mount 402 may include any suitable structure configured to rotatably attach the brace and springs to an end cap 408 with minimal friction loading. Springs 404 may be any suitable biasing devices configured to impart a force generally orthogonal to an expected sag vector. Accordingly, springs 404 may include compression springs for “ball-down” applications (as shown in the figures) or extension springs for “ball-up” applications. Brace 406 may include any suitable structure configured to rigidly connect springs 404 and an outer yoke 410.

FIG. 15 shows relationships between the sag compensation assembly and the gimbal system. A non-displaced compression spring 412 fits into a slot 414 in cap 408 at a first end of the spring. A second end of the spring interfaces with a snubber assembly 416, substantially as described in previous examples. Cap 408 is connected to a retention member 418, which is supported by central bearings 420 and connected to a retention tray 422.

As described above regarding spring 202, sag compensation assembly 400 functions as another example of a compensating bias mechanism, in this case biased to compensate for the force of gravity. In this example, spring 412 may function to provide lateral compensation to counteract the preloaded mechanical isolators.

### Example 4

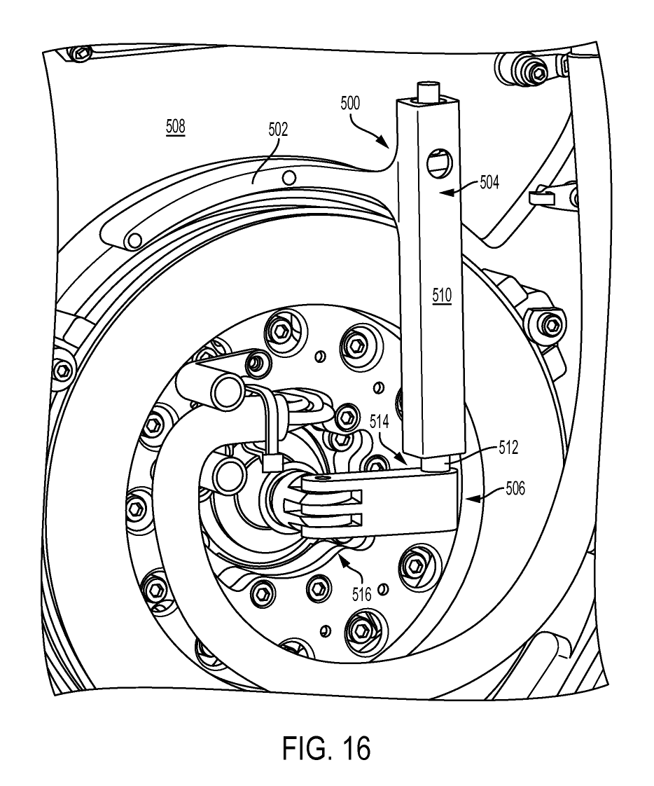

This example describes an illustrative gimbal system having another example of an externally mounted, articulating sag compensation assembly 500 between a major gimbal and a minor gimbal. The exemplary system may provide improved compensation for payload sag as described above; see FIGS. 16-20.

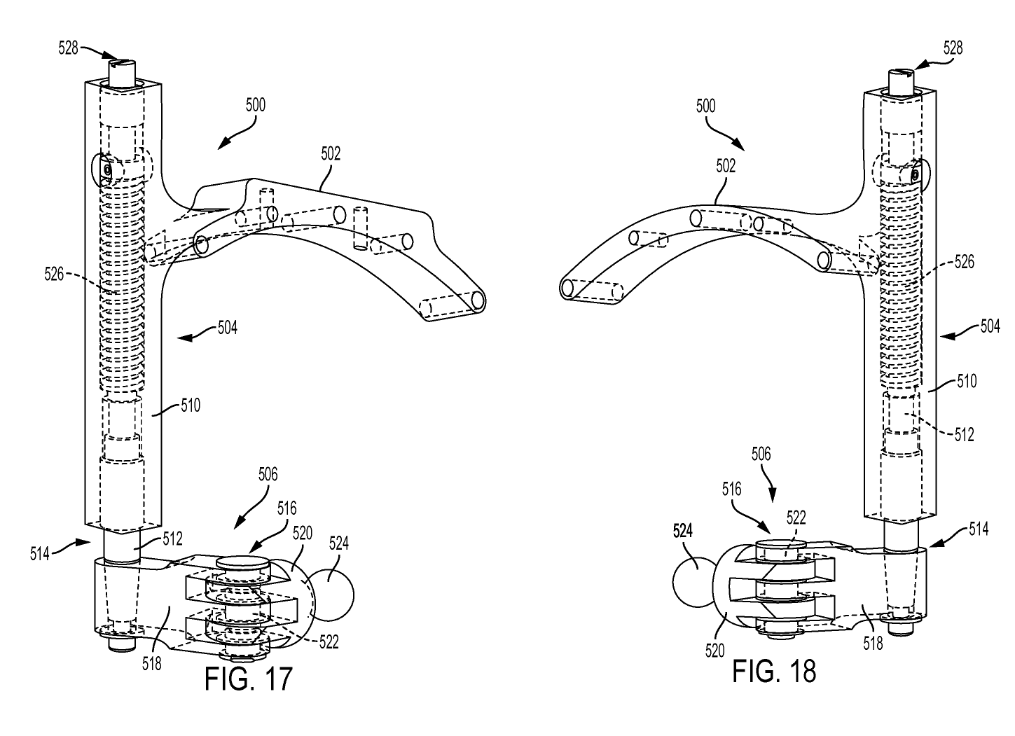

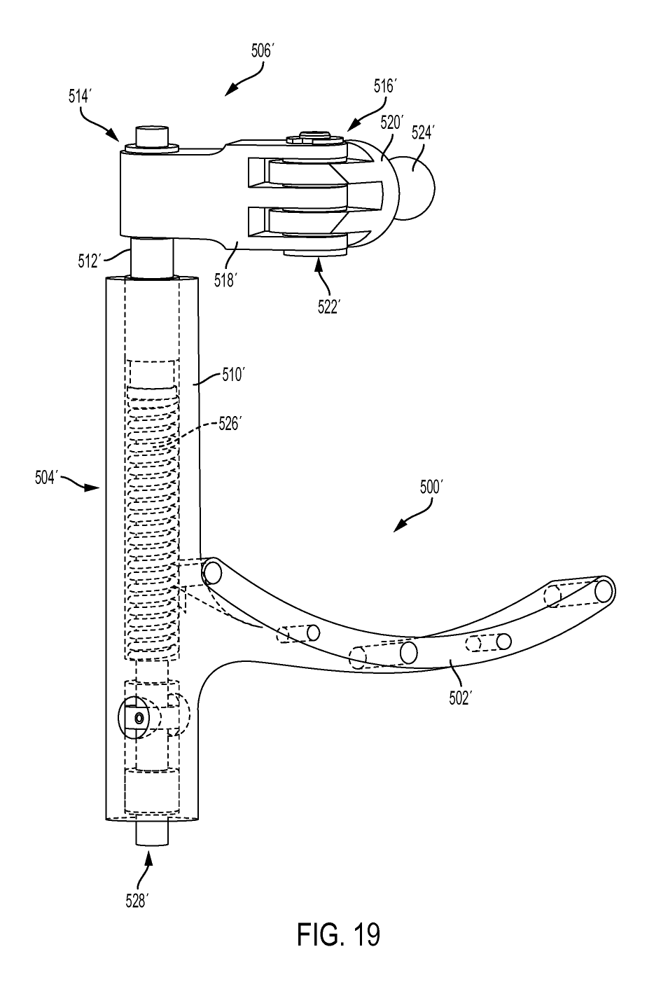

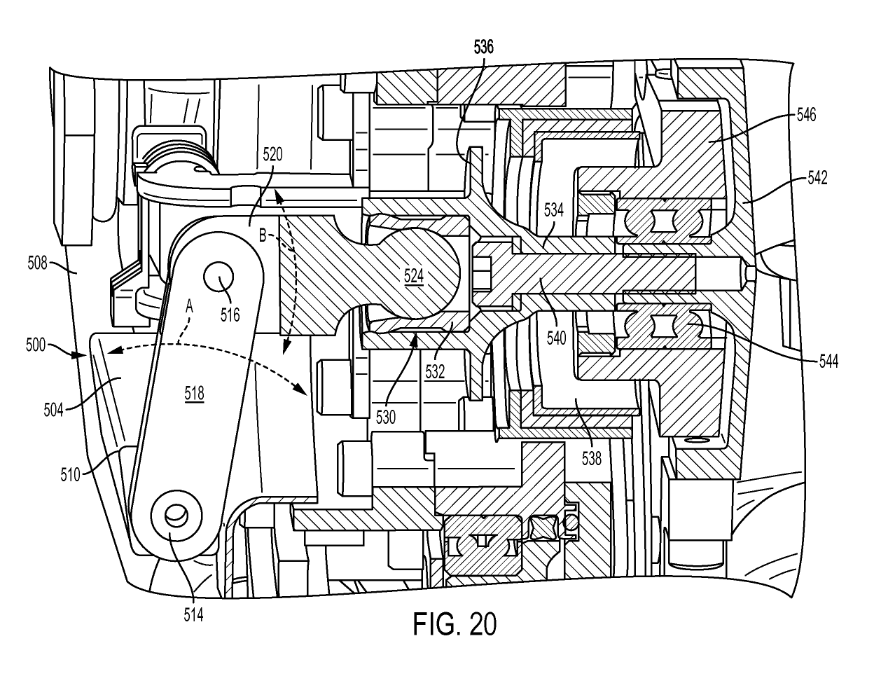

In this example, FIG. 16 is an isometric view of an outer surface of an outer yoke, showing sag compensation assembly 500 mounted to the outer yoke and coupled to the minor gimbal via an axial ball joint; FIGS. 17 and 18 are isometric views of assembly 500, showing arrangement of internal and external components; FIG. 19 is an isometric view of an inverted sag compensation assembly 500′ for use in “ball-up” gimbal systems; and FIG. 20 is a horizontal sectional view taken through a ball joint of assembly 500 and through a portion of the gimbal system.

Sag compensation assembly 500 (also referred to as a compensating bias mechanism and/or a bracing assembly) may include a mounting arm 502 extending transversely from a substantially vertical support portion 504, and an articulated gimbal interface portion 506 extending from an end of portion 504. Mounting arm 502 may include a rigid, arcuate member configured to be affixed to a surface of an outer yoke 508. Mounting arm 502 is rigidly affixed, and in some examples unitary with an outer housing 510 of support portion 504. Gimbal interface portion 506 is coupled to portion 504 through an inner shaft 512 extending through housing 510.

Gimbal interface portion 506 is articulated, having a first pivot assembly 514 where portion 506 is coupled to the inner shaft. A second pivot assembly 516 joins a first articulating member 518 with a second articulating member 520. Pivot assembly 516 comprises a hinge joint having a central pin or axle 522 defining a pivot axis that is substantially parallel to a long axis of shaft 512 and orthogonal to the gimbal axis. Articulation of gimbal interface portion 506 may facilitate offset or off-axis mounting of assembly 500, and/or may help prevent interference between the sag compensation assembly and existing cables, wiring, and the like.

Second articulating member 520 terminates in a ball portion 524 configured to interface with a socket portion of the gimbal to form a rotatable ball joint. Support portion 504 further includes a biasing member in the form of a spring 526 coaxial with shaft 512. Spring 526 may include any suitable biasing device or component configured to impart a force generally orthogonal to an expected sag vector. Accordingly, spring 526 may include an extension spring for “ball-down” applications (as shown in FIGS. 17 and 18) or a compression spring for “ball-up” applications as shown in FIG. 19. An end 528 of shaft 512 may be slotted to permit rotational manipulation to increase or decrease spring compression.

As explained above, FIG. 19 shows a substantially similar articulated sag compensation assembly 500′ having substantially similar components arranged to accommodate an inverted gimbal assembly. Accordingly, corresponding components are labeled with primed reference numbers otherwise identical to those of assembly 500.

FIG. 20 shows a partial horizontal sectional view of assembly 500 installed on a gimbal system. As depicted in FIG. 20, assembly 500 includes two pivoting degrees of freedom. Specifically, first articulating member 518 is pivotable about axis 514 (as shown at line A) and second articulating member 520 is pivotable about axis 516 (as shown at line B). A third, constrained degree of freedom may be present and described as coaxial with support portion 504, in that some movement is possible due to the biasing spring. A fourth degree of freedom is present as well, in that the inner gimbal is rotatable at a ball joint 530 formed by ball 524 and a sleeve 532.

Sleeve 532 may be a generally cylindrical sleeve portion configured to receive ball 524 in a ball-and-socket joint. Sleeve 532 may be press-fit or otherwise fixed in a corresponding opening or receptacle of a flanged snubber shaft 534 having a flange 536 and functionally similar to flanged snubber shaft 226 described above. Snubber shaft 534 may pass through snubber assembly 538, again substantially as previously described. Furthermore, a retention member 540 (similar to retention member 208) connects snubber shaft 534 to a vibration plate 542. Central bearings 544 support hub 546 of an inner ring.

Accordingly, articulating sag compensation assembly 500 is rigidly connected to an outer yoke, and provides sag compensation and support to an inner ring through a biased support shaft, an articulated end portion having a plurality of pivoting connections, and a rotatable ball joint. As described above regarding spring 202 and assembly 400, sag compensation assembly 500 functions as another example of a compensating bias mechanism, in this case biased to compensate for the force of gravity.

### Example 5

This Example describes additional aspects and features of gimbal systems, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A gimbal system comprising:

a support portion;

a gimbal assembly pivotably connected to and supported by the support portion, the gimbal assembly including a major gimbal and a minor gimbal, the minor gimbal nested within the major gimbal and pivotable on a common axis;

a vibration tray assembly including a plate having arm extensions, the plate being connected to a bearing of the pivot axis of the minor gimbal, at least one arm extension being connected to the major gimbal by a mechanical isolator; and

a payload pivotably orientable with respect to the support portion by the gimbal assembly, to provide pan and tilt movement of the payload;

wherein the minor gimbal is substantially isolated from vibration of the major gimbal by the vibration tray assembly.

A1. The system of paragraph A0, wherein the minor gimbal comprises a rigid ring.

A2. The system of paragraph A1, wherein the vibration tray assembly wraps around the ring such that no portion of the mechanical isolator is disposed between the ring and the major gimbal.

A3. The system of paragraph A1, wherein the inner ring is disposed between the plate and the major gimbal.

A4. The system of paragraph A1, wherein the inner ring comprises an aperture, and the plate connects to the bearing through the aperture.

A5. The system of paragraph A4, wherein the plate includes a protruding member configured to fit within an inner race of the bearing.

A5. The system of any other paragraph, wherein the extension arm is configured to space the mechanical isolator away from the minor gimbal.

B0. A gimbal system comprising:

a support portion;

a gimbal assembly pivotably connected to and supported by the support portion, the gimbal assembly including a major gimbal and a minor gimbal, the minor gimbal nested within the major gimbal and pivotable on a common axis;

a vibration tray assembly including a plate having arm extensions, the plate being connected to a bearing of the pivot axis of the minor gimbal, at least one arm extension being connected to the major gimbal by a mechanical isolator; and

a payload pivotably orientable with respect to the support portion by the gimbal assembly, to provide pan and tilt movement of the payload;

wherein the minor gimbal is substantially isolated from vibration of the major gimbal by the vibration tray assembly; and

wherein a space between the at least one arm extension and the major gimbal is configured to cause the mechanical isolator to be partly compressed regardless of vibration.

B1. The system of paragraph B0, wherein the space is limited by a shim.

B2. The system of paragraph B0, wherein the compression of the mechanical isolator leaves sufficient range of motion to accommodate expected vibration levels.

B3. The system of paragraph B0, further including a compensating bias mechanism operatively connected between the minor gimbal and the major gimbal, the compensating bias mechanism configured to at least partially counteract a lateral force caused by the compression of the mechanical isolator.

C0. A gimbal system comprising:

a support portion;

a gimbal assembly pivotably connected to and supported by the support portion, the gimbal assembly including a major gimbal and a minor gimbal, the minor gimbal nested within the major gimbal and pivotable on a common axis, the minor gimbal being operatively connected to the major gimbal by an assembly including a preloaded mechanical isolator;

a payload pivotably orientable with respect to the support portion by the gimbal assembly, to provide pan and tilt movement of the payload; and

a compensating bias mechanism operatively connected between the minor axis and the major axis, the bias mechanism configured to counteract lateral force caused by the preloaded mechanical isolator.

C1. The system of paragraph C0, wherein the compensating bias mechanism includes a spring.

C2. The system of paragraph C0, wherein the spring is trapped between the major gimbal and an end cap.

C3. The system of any other paragraph, wherein the spring includes a tapered helical compression spring.

C4. The system of paragraph C2, wherein the end cap is operatively connected to the minor gimbal.

C5. The system of any other paragraph wherein the end cap traps a distal end of the spring in a position offset radially from a proximal end of the spring.

C6. The system of paragraph C4, wherein the end cap traps the distal end in an eccentric slot on a surface of the end cap.

C7. The system of paragraph C2, wherein a radial force is applied to the end cap.

C8. The system of paragraph C2, wherein the radial force is applied by a biased brace assembly fixed at one end to the major gimbal and rotatably attached at an opposite end to the end cap.

C9. The system of any other paragraph wherein a radial force is applied to the compensating bias mechanism to compensate for sag of the payload due to gravity.

D0. A gimbal system comprising:

a support portion;

a gimbal assembly pivotably connected to and supported by the support portion, the gimbal assembly including a major gimbal and a minor gimbal, the minor gimbal nested within the major gimbal and pivotable on a common axis;

a payload pivotably orientable with respect to the support portion by the gimbal assembly, to provide pan and tilt movement of the payload; and

a snubber mechanism operatively connected between the minor gimbal and the major gimbal and configured to mechanically limit lateral motion of the minor gimbal relative to the major gimbal.

D1. The system of paragraph D0, wherein the snubber mechanism includes a base portion and a shaft portion having a radial flange, the shaft configured to pass through an aperture in the base portion as limited by the flange.

D2. The system of paragraph D1, wherein the base portion is attached to one of the minor gimbal and the major gimbal and the shaft portion is attached to the other of the minor gimbal and the major gimbal.

D3. The system of any other paragraph, the snubber mechanism further including a resilient portion configured to cushion the snubbing action.

D4. The system of paragraph D3, wherein the base portion comprises a plurality of sandwiched layers, at least one layer comprising a resilient material.

D5. The system of paragraph D1 wherein the base portion includes a major face and a wall surrounding the face, the face and wall configured to support an end of a helical spring.

D6. The system of any paragraph, wherein the snubber mechanism is configured to snub lateral motion in two directions.

D7. The system of paragraph D6, the snubber mechanism having a major face configured to stop a hub of the minor gimbal in one direction and a flanged shaft in the other direction.

E0. A method for providing vibration isolation between two gimbals of a gimbal assembly, the method comprising:

operatively connecting a major gimbal to a minor gimbal via a pivoting axis and at least one preloaded mechanical isolator; and

compensating for axial force caused by the preloaded mechanical isolator by providing a biased compensation mechanism between the major gimbal and the minor gimbal, the compensation mechanism exerting a force substantially equal and opposite to the preload force.

E1. The method of paragraph E0, wherein operatively connecting the major and minor gimbals includes using a rigid plate having extension arms, and connecting each of the extension arms to a corresponding mechanical isolator and the plate to the pivoting axis.

E2. The method of paragraph E1, wherein the plate and arms wrap around the minor axis.

E3. The method of paragraph E0, wherein the compensation mechanism is coaxial with the pivoting axis.

E4. The method of paragraph E0, wherein the biased compensation mechanism includes a helical spring.

E5. The method of paragraph E4, wherein the spring is tapered from a proximal end to a distal end.

E6. The method of paragraph E5, further including displacing the distal end of the spring in a radial direction.

E7. The method of paragraph E6, wherein displacing the distal end includes displacing the distal end by a fixed amount selected to counteract sagging of the minor axis on the mechanical isolator(s).

F0. A gimbal system comprising:

a support portion;

a gimbal assembly pivotably connected to and supported by the support portion, the gimbal assembly including a major gimbal and a minor gimbal, the minor gimbal nested within the major gimbal and pivotable on a common axis, the minor gimbal being operatively connected to the major gimbal by an assembly including a preloaded mechanical isolator;

a payload pivotably orientable with respect to the support portion by the gimbal assembly, to provide pan and tilt movement of the payload; and

a compensating bias mechanism operatively connected between the minor gimbal and the major gimbal.

F1. The system of paragraph F0, further including a snubber mechanism operatively connected between the minor gimbal and the major gimbal and configured to mechanically limit lateral motion of the minor gimbal relative to the major gimbal.

F2. The system of paragraph F1, wherein the snubber mechanism includes a base portion and a shaft portion having a radial flange, the shaft portion configured to pass through an aperture in the base portion, as limited by the radial flange.

F3. The system of paragraph F2, wherein the base portion is operatively connected to one of the minor gimbal and the major gimbal and the shaft portion is operatively connected to the other of the minor gimbal and the major gimbal.

F4. The system of paragraph F2, the snubber mechanism further including a resilient portion configured to cushion the snubbing action.

F5. The system of paragraph F4, wherein the base portion comprises a plurality of sandwiched layers, at least one layer comprising a resilient material.

F6. The system of paragraph F0, wherein the compensating bias mechanism is configured to at least partially counteract a lateral force caused by the preloaded mechanical isolator.

F7. The system of paragraph F0, wherein the compensating bias mechanism includes a bracing assembly, the bracing assembly having a first end portion rigidly coupled to the major gimbal, and a second end portion coupled to the minor gimbal, the bracing assembly being biased such that a second lateral force is imparted on the minor gimbal by the second end, the second lateral force at least partially opposing the first lateral force.

F8. The system of paragraph F7, wherein the second end portion of the bracing assembly is articulated.

F9. The system of paragraph F8, wherein the second end portion of the bracing assembly has at least one joint pivotable on an axis transverse to the common axis of the major and minor gimbals.

F10. The system of paragraph F7, wherein the second end of the bracing assembly is coupled to the preloaded mechanical isolator through a rotatable ball joint.

F11. The system of paragraph F7, wherein the bracing assembly includes a biased shaft having a long axis oriented transverse to the common axis of the major and minor gimbals.

### CONCLUSION

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Invention(s) embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the invention(s) of the present disclosure.

1. A gimbal system comprising:
a support portion;
a gimbal assembly pivotably connected to and supported by the support portion, the gimbal assembly including a major gimbal and a minor gimbal, the minor gimbal nested within the major gimbal and pivotable on a common axis;
a vibration tray assembly including a plate having arm extensions, the plate being connected to a bearing of the pivot axis of the minor gimbal, at least one arm extension being connected to the major gimbal by a mechanical isolator; and
a payload pivotably orientable with respect to the support portion by the gimbal assembly, to provide pan and tilt movement of the payload;
wherein the minor gimbal is substantially isolated from vibration of the major gimbal by the vibration tray assembly.

2. The system of claim 1, wherein the minor gimbal comprises a rigid ring.

3. The system of claim 2, wherein the vibration tray assembly wraps around the ring such that no portion of the mechanical isolator is disposed between the ring and the major gimbal.

4. The system of claim 2, wherein the inner ring is disposed between the plate and the major gimbal.

5. The system of claim 2, wherein the inner ring comprises an aperture, and the plate connects to the bearing through the aperture.

6. The system of claim 5, wherein the plate includes a protruding member configured to fit within an inner race of the bearing.

7. A gimbal system comprising:
a support portion;
a gimbal assembly pivotably connected to and supported by the support portion, the gimbal assembly including a major gimbal and a minor gimbal, the minor gimbal nested within the major gimbal and pivotable on a common axis;
a vibration tray assembly including a plate having arm extensions, the plate being connected to a bearing of the pivot axis of the minor gimbal, at least one arm extension being connected to the major gimbal by a mechanical isolator; and
a payload pivotably orientable with respect to the support portion by the gimbal assembly, to provide pan and tilt movement of the payload;
wherein the minor gimbal is substantially isolated from vibration of the major gimbal by the vibration tray assembly; and
wherein a space between the at least one arm extension and the major gimbal is configured to cause the mechanical isolator to be partly compressed regardless of vibration.

8. The system of claim 7, further including a compensating bias mechanism operatively connected between the minor gimbal and the major gimbal, the compensating bias mechanism configured to at least partially counteract a lateral force caused by the compression of the mechanical isolator.

9. The system of claim 7, wherein the compression of the mechanical isolator leaves sufficient range of motion to accommodate expected vibration levels.

10. A gimbal system comprising:
a support portion;
a gimbal assembly pivotably connected to and supported by the support portion, the gimbal assembly including a major gimbal and a minor gimbal, the minor gimbal nested within the major gimbal and pivotable on a common axis, the minor gimbal being operatively connected to the major gimbal by an assembly including a preloaded mechanical isolator;
a payload pivotably orientable with respect to the support portion by the gimbal assembly, to provide pan and tilt movement of the payload; and
a compensating bias mechanism operatively connected between the minor gimbal and the major gimbal.

11. The system of claim 10, further including a snubber mechanism operatively connected between the minor gimbal and the major gimbal and configured to mechanically limit lateral motion of the minor gimbal relative to the major gimbal.

12. The system of claim 11, wherein the snubber mechanism includes a base portion and a shaft portion having a radial flange, the shaft portion configured to pass through an aperture in the base portion, as limited by the radial flange.

13. The system of claim 12, wherein the base portion is operatively connected to one of the minor gimbal and the major gimbal and the shaft portion is operatively connected to the other of the minor gimbal and the major gimbal.

14. The system of claim 12, the snubber mechanism further including a resilient portion configured to cushion the snubbing action.

15. The system of claim 10, wherein the compensating bias mechanism is configured to at least partially counteract a lateral force caused by the preloaded mechanical isolator.

16. The system of claim 10, wherein the compensating bias mechanism includes a bracing assembly, the bracing assembly having a first end portion rigidly coupled to the major gimbal, and a second end portion coupled to the minor gimbal, the bracing assembly being biased such that a compensating force is imparted on the minor gimbal by the second end, the compensating force at least partially opposing the force of gravity.

17. The system of claim 16, wherein the second end portion of the bracing assembly is articulated.

18. The system of claim 17, wherein the second end portion of the bracing assembly has at least one joint pivotable on an axis transverse to the common axis of the major and minor gimbals.

19. The system of claim 16, wherein the second end of the bracing assembly is coupled to the preloaded mechanical isolator through a rotatable ball joint.

20. The system of claim 16, wherein the bracing assembly includes a biased shaft having a long axis oriented transverse to the common axis of the major and minor gimbals.
